(19) United States
(12) Patent Application Publication
(10) Pub. No.: US 2004/0017315 A1
(43) Pub. Date: Jan. 29, 2004

(54) Dual-band antenna apparatus

(76) Inventors: Shyh-Tirng Fang, Tainan (TW); Hao-Chun Tung, Kinmen (TW); Kin-Lu Wong, Kaohsiung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/342,503

(22) Filed: Jan. 15, 2003

(30) Foreign Application Priority Data
Jul. 24, 2002 (TW) 091116519

(51) Int. Cl. H01Q 9/28

(52) U.S. Cl. 343/700 MS

(57) ABSTRACT

One dual-band monopole antenna composed of a microwave substrate, radiation devices and transmission line is disclosed. The radiation device includes the central radiation body and two radiation arms. The central radiation body is used to generate one resonance mode, and the two radiation arms are used to generate another resonance mode. Thus, the dual-band monopole antenna is capable of operating at two different frequencies. In practical applications, radiation arms can be put symmetrically on two opposite sides and close to the central radiation body.

This application claims the benefit of Taiwan application Serial No. 091116519, filed on Jul. 24, 2002.

### BACKGROUND OF THE INVENTION

1. Field of the Invention

The invention is related to a dual-band antenna, and more particularly to a dual-band monopole antenna.

2. Description of the Related Art

As a result of the prosperous growth of the communication industry, various radio frequency (RF) products are commercially available in a short period of time. For the wireless local area network, its related products own rather high market value and attraction. Antenna design is one of the key techniques in wireless system. Monopole antennas with long linear conductors are widely used in wireless local area network (WLAN) related products. Its large volume and complicated structure limit its application. Furthermore, the monopole antennas with long linear conductors need additional matching circuit, which results in high manufacturing cost.

On the other hand, high frequency RF signal (5.2 GHz for example) transmission can be easily interfered by landforms and decays rapidly. For this reason, the transmission distance and signal quality will be affected seriously. In terms of wireless transmission applications, not only the convenience of dual-band operation but also high frequency antenna gain must be considered. Thus, how to enhance the performance and the operation of all communication system in high-frequency band (such as the 5.2 GHz band (5.15-5.35 GHz), is the hot issue nowadays.

### SUMMARY OF THE INVENTION

It is therefore an object of the invention to provide a dual-band monopole antenna of low manufacturing cost.

Another object is to provide a dual-band monopole antenna with both characteristics of high antenna gain and dual-band operation.

In accordance with the object of the invention, it provides a dual-band monopole antenna, which is concisely described as follows.

Dual-band monopole antenna can be manufactured by microwave substrate, and the radiation devices can be formed on surface of microwave substrate by printing technology or etching technology. Radiation device is composed of a central radiation body and two radiation arms. To make dual-band antenna capable of performing two different frequency operations, the central radiation body is used to generate a resonance mode, and the two radiation arms are used to generate another resonance mode. In practical applications, the radiation arms can be arranged symmetrically and on opposite sides of the central radiation body. In addition, the use of two radiation arms makes the antenna radiation field enhanced to increase antenna gain.

Further, in order to make the purpose, feature and advantage of the invention more obviously understood, one preferred embodiment is described in detail with figures.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates a dual-band monopole antenna according to the preferred embodiment of the present invention;

FIG. 2 illustrates assembly of radiation device in FIG. 1;

FIG. 3 illustrates measurement of return loss of dual-band monopole antenna in FIG. 1;

FIG. 4 illustrates measurement of antenna gain of dual-band monopole antenna operating in the 2.4 GHz band;

FIG. 5 illustrates measured value of antenna gain of dual-band monopole antenna operating in the 5.2 GHz band;

FIG. 6 illustrates a transformation of the radiation device in FIG. 1; and

FIG. 7 illustrates another transformation of radiation device in FIG.

### DESCRIPTION OF THE PREFERRED EMBODIMENT

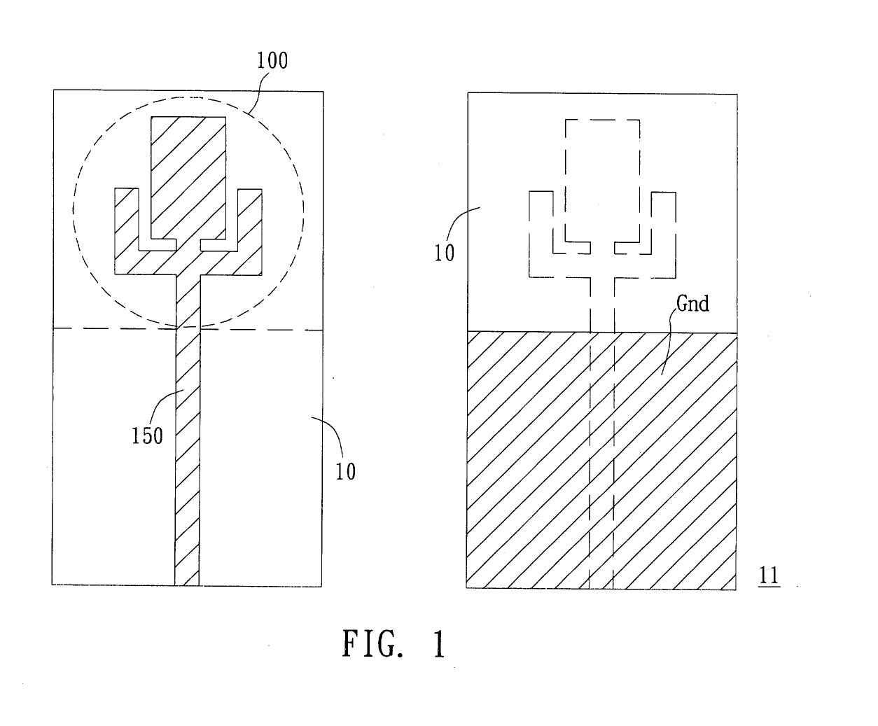

Referring to FIG. 1, a dual-band monopole antenna 11 is provided according to the preferred embodiment of the present invention. The dual-band monopole antenna 11 can be manufactured by using a microwave substrate 10 as a substrate. On the microwave substrate 10, a radiation device 100 can be formed by printing technology or etching technology to generate two resonance modes. For signal transmission, while a microstrip line is used as a transmission line, the microstrip line 150 can be settled on the topside of the microwave substrate 10 for connecting the radiation devices 100, and a grounding surface (Gnd) corresponding to the microstrip line 150 is set on the backside of microwave substrate 10. As one skilled in the art knows, a coplanar waveguide (CPW) or coaxial cable can also be used to be the transmission line for connecting radiation device 100 to transmit antenna signal.

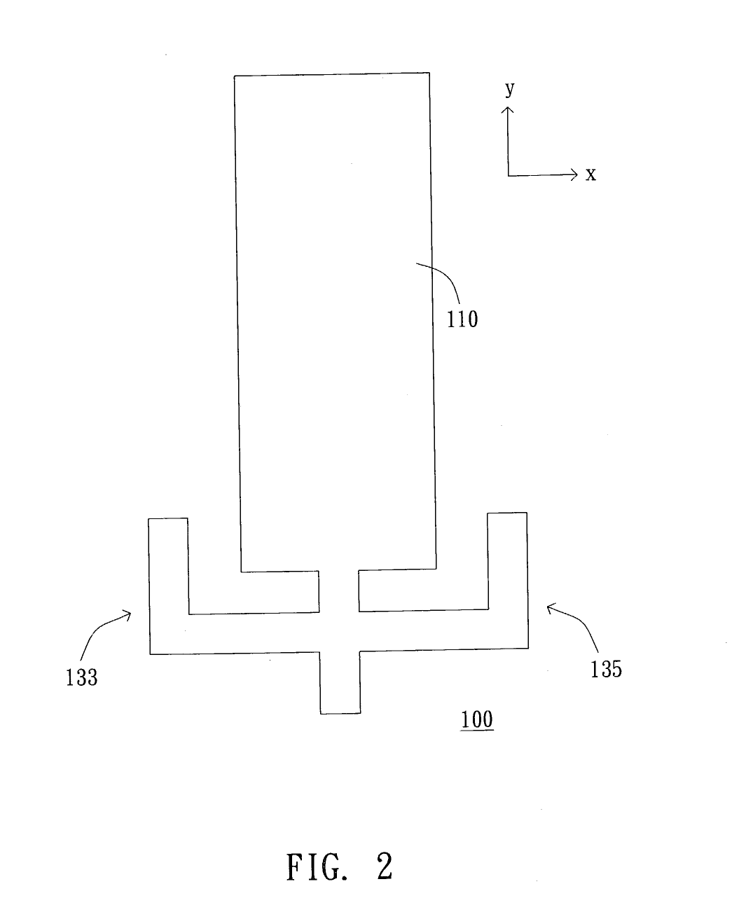

Referring now to FIG. 2, it illustrates the assembly of the radiation device 100. The radiation device 100 includes a central radiation body 110 and radiation arms 133, 135. The central radiation body 110 is used to generate the first resonance mode of the first operating frequency, and the radiation arms 133, 135 are used to generate the second resonance mode of the second operating frequency. The length of the central radiation body 110 can be designed to be longer than the length of the radiation arms 133 and 135, so that the central radiation body 110 can resonate at lower frequency. Taking the wireless local area network as an example, the antenna is preferred to have two operating frequency bands at 2.4 GHz and 5.2 GHz. The length of the central radiation body 110 is accordingly a quarter of the wavelength of 2.4 GHz and the lengths of the radiation arms 133, 135 are accordingly a quarter of the wavelength of 5.2 GHz. According to the spirit of the invention, the radiation arms 133 and 135 are symmetrical and are respectively positioned on two opposite sides of the central radiation body 110 by bending for a specific angle. Referring to the radiation body shown in FIG. 2, wherein the central radiation body 110 is a rectangular structure, the radiation arms 133 and 135 are bent for about 90 degrees to be positioned on the left and right sides of the central radiation body 110. The radiation arms 133 and 135 are both close to the central radiation body 110, which makes the proposed antenna have a smaller lateral width.

In order to have high antenna gain during operation, two radiation arms are used. The radiation arms 133 and 135 are preferably set symmetrical and extended in the same directions (along y-axis as shown in FIG. 2). By this arrangement, the radiation field of the antenna is nearly omnidirectional in azimuth angle plane. As a result, good impedance match for the proposed antenna can be obtained without additional match circuit, and consequently a dual-band antenna can be manufactured in lower cost.

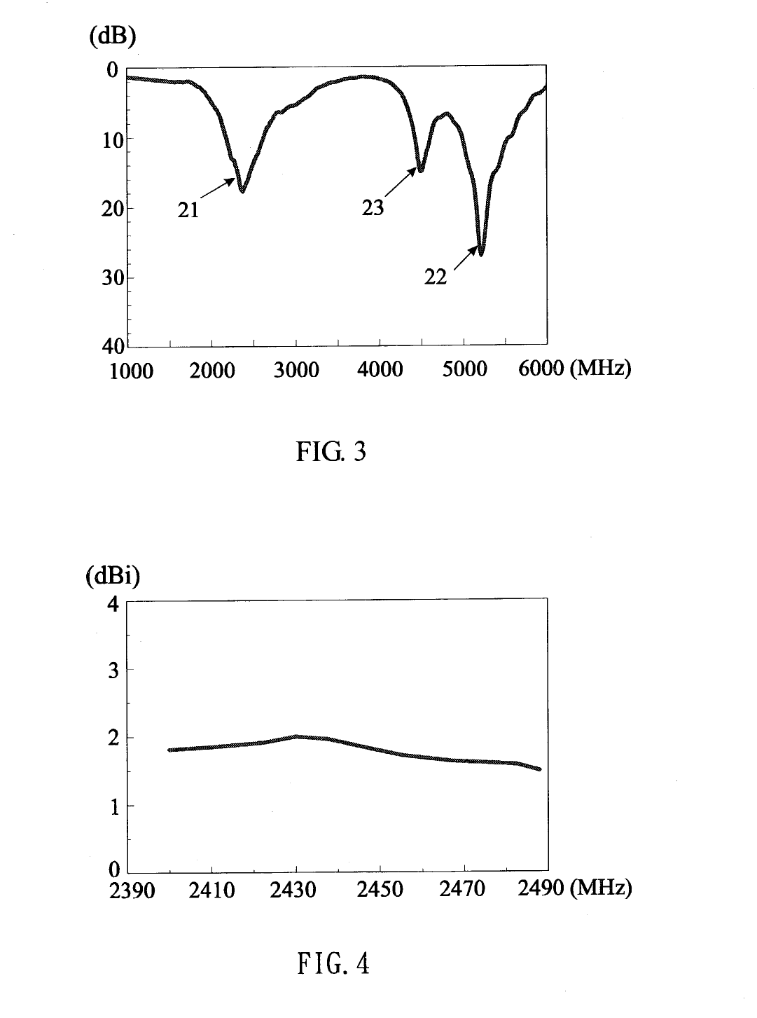

Referring to FIG. 3, it shows the return loss of the dual-band monopole antenna 11. The dielectric coefficient of the microwave substrate 10 is about 4.4, the thickness of the microwave substrate 10 is about 0.4 mm, and the length of the microwave substrate 10 is about 57 mm. The length of the central radiation body 110 is about 25 mm. The resonance mode 21 and the resonance mode 23 are generated when the central radiation body 110 is excited. The corresponding operating frequency of the resonance mode 21 is 2.4 GHz, and the operating frequency of the resonance mode 23 is two times of the frequency of the resonance mode 21. And the lengths of the radiation arms 133, 135 are about 13 mm. The resonance mode 22 is generated when the radiation arms 133, 135 are excited. The corresponding operating frequency of the resonance mode 22 is about 5.2 GHz. In terms of frequency band, if 1.5:1 voltage standing wave ratio (VSWR) or 14 dB return loss is defined, the frequency band is 112 MHz when operating at about 2.4 GHz, and the frequency band is 310 MHz when operating at about 5.2 GHz, which meet respectively the frequency band requirements of wireless local area network when operating in the 2.4 GHz (2.4˜2.484 GHz) and 5.2 GHz (5.15˜5.35 GHz) bands.

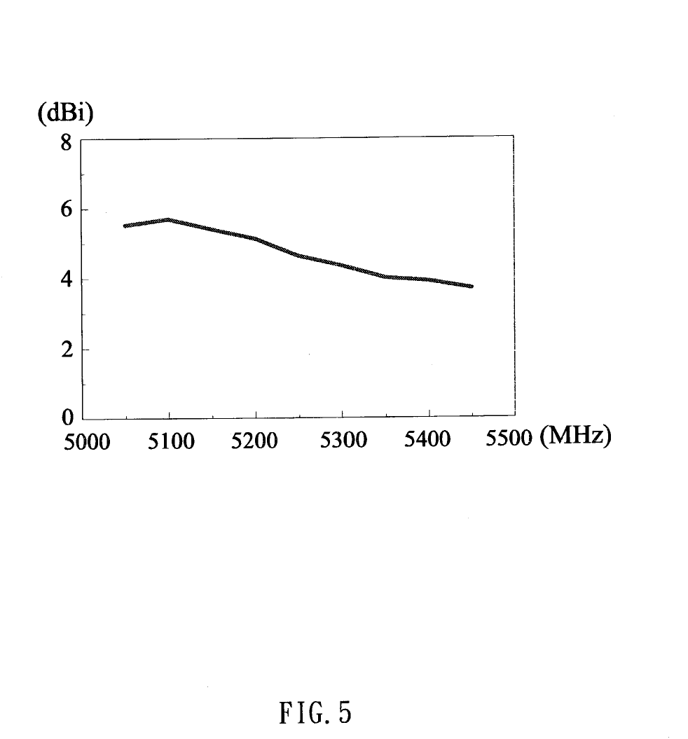

Referring to FIG. 4, it shows the antenna gain of the dual-band monopole antenna 11 operating in the 2.4 GHz band. It is revealed that the antenna gain can reach up to 2.1 dBi. FIG. 5 shows the antenna gain of the dual-band monopole antenna 11 operating in the 5.2 GHz band. It is revealed that the antenna gain can reach up to 5.7 dBi. By FIG. 4 and FIG. 5, the dual-band monopole antenna provided by the present invention is capable of having high antenna gain for dual-band operation, especially for operating in the higher frequency band.

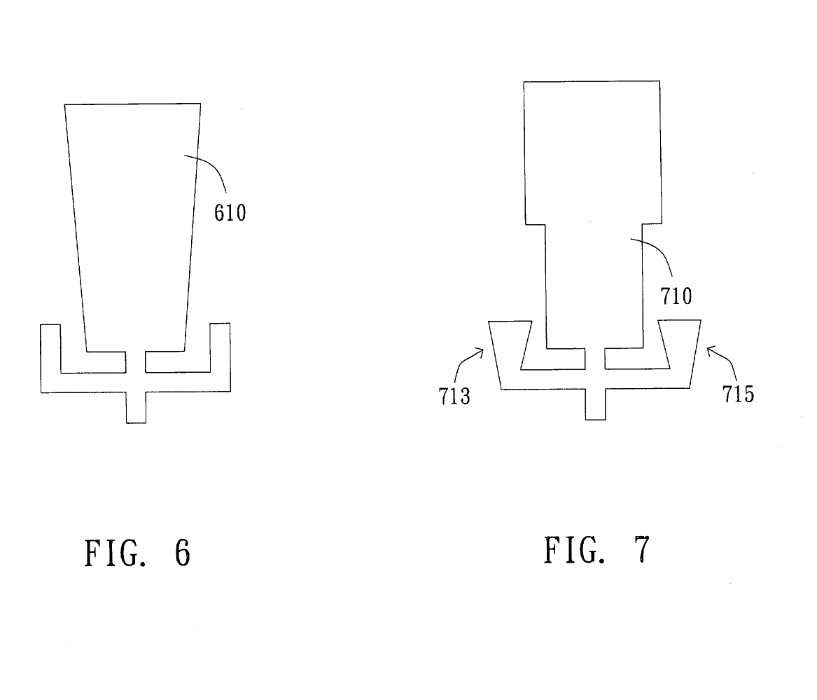

Some trivial deformations of the feature of the central radiation body or the radiation arms for the proposed invention are also within the scope of the invention. For example, the width of the central radiation body 610 in FIG. 6 can be modified to increase linearly, the width of the central radiation body 710 in FIG. 7 can be modified to increase in stepping or the widths of the radiation arms 713, 715 can be modified to increase linearly. These modifications of the features do not influence the applicability of the present invention. Other modifications like forming slot or slit at the edge or internal of the central radiation body 710 or the radiation arms 713, 715 for the purpose of miniaturizing the product size, do not substantially affect the performance of the invention.

The width of the dual-band monopole antenna operating in the 2.4 GHz and 5.2 GHz bands according to the embodiment of present invention is only about 12 mm, which is very close to the popular long linear monopole antenna and is ideal for dual-band operations of wireless local area network. In addition, the embodiment of present invention provides almost omni-directional radiation field operation at azimuth angle plane, and good antenna gain performance at two operating frequency. Low frequency antenna gain is 2.1 dBi and high frequency antenna gain is 5.7 dBi, which is very suitable for application in the base station or access point of current wireless local area networks.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dual-band monopole antenna apparatus, comprising:
a microwave substrate;
a radiation device, formed on a surface of the microwave substrate for generating a first resonance mode and a second resonance mode, so that a first operating frequency corresponding to the first resonance mode and a second operating frequency corresponding to the second resonance mode are formed, the radiation device including:
a central radiation body for generating the first resonance mode; and
one pair of radiation arms for generating the second resonance mode, the radiation arms being positioned symmetrically on two opposite sides of the central radiation body and extended in the same directions; and
a transmission line coupling with the central radiation body and the radiation arms for transmitting signals.

2. A dual-band monopole antenna apparatus according to claim 1, wherein the first operating frequency is lower than the second operating frequency.

3. A dual-band monopole antenna apparatus according to claim 2, wherein the first operating frequency is about 2.4 GHz and the second operating frequency is about 5.2 GHz.

4. A dual-band monopole antenna apparatus according to claim 1, wherein the length of the central radiation body is about a quarter of the wavelength corresponding to the first operating frequency.

5. A dual-band monopole antenna apparatus according to claim 1, wherein the lengths of the radiation arms are about a quarter of the wavelength corresponding to the second operating frequency.

6. A dual-band monopole antenna apparatus according to claim 1, wherein the transmission line is a microstrip line.

7. A dual-band monopole antenna apparatus according to claim 1, wherein the transmission line is a coaxial cable.

8. A dual-band monopole antenna apparatus according to claim 1, wherein the transmission line is a coplanar waveguide.

9. A dual-band monopole antenna apparatus according to claim 1, wherein the central radiation body is a rectangular structure.

10. A dual-band monopole antenna apparatus according to claim 1, wherein the width of the central radiation body increases in stepping.

11. A dual-band monopole antenna apparatus according to claim 1, wherein the width of the central radiation body increases linearly.

12. A dual-band monopole antenna apparatus according to claim 1, wherein the widths of the radiation arms remain constant.

13. A dual-band monopole antenna-apparatus according to claim 1, wherein the widths of the radiation arms increase linearly.
